(19) United States
(12) Patent Application Publication
(10) Pub. No.: US 2026/0119880 A1
(43) Pub. Date: Apr. 30, 2026

(54) SYSTEM AND METHOD FOR CONTENT ANALYSIS AND PREDICTIVE FORECASTING

(71) Applicant: Royal Bank of Canada, Toronto (CA)

(72) Inventors: Graham Alexander WATT, Toronto (CA); Yixiang XIA, Toronto (CA); Yuri LAWRYSHYN, Toronto (CA); Yung Kei Truman YUEN, Toronto (CA)

(21) Appl. No.: 19/376,363

(22) Filed: Oct. 31, 2025

Related U.S. Application Data
(60) Provisional application No. 63/714,236, filed on Oct. 31, 2024.

(51) Int. Cl. G06N 3/082; G01W 1/00; G06N 20/00

(52) U.S. Cl. CPC G06N 3/082; G01W 1/00; G06N 20/00

(57) ABSTRACT

There is provided a system incorporating a combination of generative pre-trained transformer (GPT) insights with a predictive model to generate predictions. The predictive model may be a Long Short-Term Memory (LSTM) network. A GPT can be used to conduct qualitative analytics of an event, which are subsequently converted to quantitative features. These quantitative features may be leveraged by the predictive model incorporating to combine historical quantitative data with GPT-generated features. The hybrid GPT-LSTM system may be configured to generate forecasts and predictions for effects and consequences of future events.

### CROSS-REFERENCE TO RELATED APPLICATIONS

This claims the benefit of, and priority to, U.S. Provisional Patent Application No. 63/714,236, filed Oct. 31, 2024, the entire contents of which are incorporated by reference herein.

### FIELD

This disclosure relates to the use of generative computing architectures and quantitative models, and in particular to predictive forecasting.

### BACKGROUND

As time goes on, many extreme weather events and, more generally, acute physical climate risk events, are increasing in both frequency and severity. The consequences of such events can have far-reaching implications due to the increasingly interconnected and globalized nature of modern life. Predicting such consequences (e.g., a widespread drought for a particular crop might increase the price of that crop) can be challenging, particularly when attempting to characterize such consequences quantitatively (e.g., the price of the crop will increase by 43% over the next 6 months). Predicting cascading effects (also referred to as “knock-on” effects (e.g., the cost of animal feed containing that crop may rise, which will affect the market price for meat from that animal)) is even more complicated to model and compute.

Moreover, previous strategies for quantitatively computing any such predictions require significant computing power, which may be both prohibitively expensive and/or impractical to access, and unsuitable from a scalability perspective. Such strategies often rely on probabilistic models which are known to perform poorly when there are complex data requirements and interdependencies.

Accordingly, there is a need for systems and methods which can reduce the computing load required to generate predictions involving inter-related assets and effects of events, and to improve the accuracy of generated predictions. Moreover, there is a need for systems which can accurately predict and manage the economic consequences of events (such as extreme climate and/or weather events).

### SUMMARY

According to an aspect, there is provided a method of analyzing data and generating predictive forecasts, the method comprising: receiving, at a qualitative analysis module, historical event data comprising text data describing a plurality of events over a first time period; extracting, from said training data, a plurality of features using a generative pre-trained transformer (GPT); transforming said extracted features to a numerical value; receiving, at a data preparation module, historical financial data for one or more assets over a second time period; determining one or more metrics based on said historical financial data; generating a plurality of training sequences including said transformed numerical values of said extracted features and said one or more metrics; training, at a quantitative analysis module, a long short term memory (LSTM) model using said plurality of training sequences; receiving text data relating to a current event outside of said first time period; extracting, from said text data relating to said current event, a plurality of current features using said GPT; generating a plurality of sequences including transformed numerical values of said current features, and metrics derived from said historical financial data; and generating, by said LSTM model, a prediction relating to one or more of said metrics for one or more of said assets for a future time period.

According to another aspect, there is provided a system comprising: one or more processors; a non-transitory computer-readable storage medium having stored thereon processor-executable instructions that, when executed by said one or more processors, cause said one or more processors to perform a method of analyzing data and generating predictive forecasts, the method comprising: receiving, at a qualitative analysis module, historical event data comprising text data describing a plurality of events over a first time period; extracting, from said training data, a plurality of features using a generative pre-trained transformer (GPT); transforming said extracted features to a numerical value; receiving, at a data preparation module, historical financial data for one or more assets over a second time period; determining one or more metrics based on said historical financial data; generating a plurality of training sequences including said transformed numerical values of said extracted features and said one or more metrics; training, at a quantitative analysis module, a long short term memory (LSTM) model using said plurality of training sequences; receiving text data relating to a current event outside of said first time period; extracting, from said text data relating to said current event, a plurality of current features using said GPT; generating a plurality of sequences including transformed numerical values of said current features, and metrics derived from said historical financial data; and generating, by said LSTM model, a prediction relating to one or more of said metrics for one or more of said assets for a future time period.

According to still another aspect, there is provided a computer-readable storage medium having stored thereon computer-executable instructions that, when executed by one or more processors, cause the one or more processors to perform a method of analyzing data and generating predictive forecasts, the method comprising: receiving, at a qualitative analysis module, historical event data comprising text data describing a plurality of events over a first time period; extracting, from said training data, a plurality of features using a generative pre-trained transformer (GPT); transforming said extracted features to a numerical value; receiving, at a data preparation module, historical financial data for one or more assets over a second time period; determining one or more metrics based on said historical financial data; generating a plurality of training sequences including said transformed numerical values of said extracted features and said one or more metrics; training, at a quantitative analysis module, a long short term memory (LSTM) model using said plurality of training sequences; receiving text data relating to a current event outside of said first time period; extracting, from said text data relating to said current event, a plurality of current features using said GPT; generating a plurality of sequences including transformed numerical values of said current features, and metrics derived from said historical financial data; and generating, by said LSTM model, a prediction relating to one or more of said metrics for one or more of said assets for a future time period.

According to still another aspect, there is provided a method of analyzing data and generating predictive forecasts, the method comprising: receiving, at a qualitative analysis module, historical event data comprising text data describing a plurality of events over a first time period; extracting, from said historical event data, a plurality of features using a generative pre-trained transformer (GPT); transforming said extracted features to a numerical value; receiving, at a data preparation module, historical financial data for one or more assets over a second time period; determining one or more metrics based on said historical financial data; generating at least one training sequence including said transformed numerical values of said extracted features and said one or more metrics; training, at a quantitative analysis module, a predictive model using said at least one training sequence; receiving text data relating to a current event outside of said first time period; extracting, from said text data relating to said current event, a plurality of current features using said GPT; generating, by said predictive model, a prediction relating to one or more of said metrics for one or more of said assets for a future time period.

According to still another aspect, there is provided a system comprising: one or more processors; a non-transitory computer-readable storage medium having stored thereon processor-executable instructions that, when executed by said one or more processors, cause said one or more processors to perform a method of analyzing data and generating predictive forecasts, the method comprising: receiving, at a qualitative analysis module, historical event data comprising text data describing a plurality of events over a first time period; extracting, from said historical event data, a plurality of features using a generative pre-trained transformer (GPT); transforming said extracted features to a numerical value; receiving, at a data preparation module, historical financial data for one or more assets over a second time period; determining one or more metrics based on said historical financial data; generating at least one training sequence including said transformed numerical values of said extracted features and said one or more metrics; training, at a quantitative analysis module, a predictive model using said at least one training sequence; receiving text data relating to a current event outside of said first time period; extracting, from said text data relating to said current event, a plurality of current features using said GPT; and generating, by said predictive model, a prediction relating to one or more of said metrics for one or more of said assets for a future time period.

According to still another aspect, there is provided a computer-readable storage medium having stored thereon computer-executable instructions that, when executed by one or more processors, cause the one or more processors to perform a method of analyzing data and generating predictive forecasts, the method comprising: receiving, at a qualitative analysis module, historical event data comprising text data describing a plurality of events over a first time period; extracting, from said historical event data, a plurality of features using a generative pre-trained transformer (GPT); transforming said extracted features to a numerical value; receiving, at a data preparation module, historical financial data for one or more assets over a second time period; determining one or more metrics based on said historical financial data; generating at least one training sequence including said transformed numerical values of said extracted features and said one or more metrics; training, at a quantitative analysis module, a predictive model using said plurality of training sequences; receiving text data relating to a current event outside of said first time period; extracting, from said text data relating to said current event, a plurality of current features using said GPT; and generating, by said LSTM model, a prediction relating to one or more of said metrics for one or more of said assets for a future time period.

Other features will become apparent from the drawings in conjunction with the following description.

### BRIEF DESCRIPTION OF DRAWINGS

In the figures which illustrate example embodiments,

FIG. 1 is a block diagram depicting components of an example computing system;

FIG. 2 is a block diagram depicting components of an example computing device;

FIG. 3 depicts a simplified arrangement of software at computing device;

FIG. 4 depicts a logical arrangement of components of an example analysis and prediction generation system, in accordance with some embodiments;

FIG. 5 is a flow chart depicting example operations for a hybrid GPT-LSTM predictive modeling pipeline, in accordance with some embodiments;

FIG. 6 depicts an example data preparation process, in accordance with some embodiments;

FIG. 7 depicts a list of example features which may be integrated into a quantitative model to refine volatility forecasts, in accordance with some embodiments;

FIG. 8 depicts an example enhanced LSTM architecture, in accordance with some embodiments;

FIG. 9 is a table outlining the various layers depicted in the enhanced LSTM architecture of FIG. 8;

FIG. 10 depicts an example workflow diagram for generating predictions using an analysis and prediction system, in accordance with some embodiments;

FIG. 11 is a table depicting a comparison of the results of a baseline LSTM model with an enhanced GPT-LSTM model, in accordance with some embodiments;

FIG. 12 is a table depicting an example summary of predictions for various commodities using an enhanced GPT-LSTM model, in accordance with some embodiments;

FIG. 13 is a table showing a comparison of predicted volatility data using a baseline LSTM model, predicted volatility using an enhanced GPT-LSTM model, and actual volatility data for the July 2023 time period;

FIG. 14 depicts example weekly volatility data using the EWMA metric for various commodities between Jun. 25, 2018 to Dec. 20, 2024; and

FIG. 15 depicts an example record from the US Billion-Dollar Weather and Climate Disasters dataset.

### DETAILED DESCRIPTION

Some embodiments described herein may relate to the integration of generative pre-trained transformers (GPTs) together with long short-term memory (LSTM) networks to provide more computationally efficient and accurate predictions. That is, some embodiments may relate to incorporating text-based GPT language models into numerical deep learning models to improve predictive accuracy. In some embodiments, qualitative analysis results from a GPT may be transformed into quantitative features, which may represent an improvement to conventional systems. In still further embodiments, there is a feedback loop in which the quantitative model may inform the GPT and the user, which may further improve predictions. Such systems may be used in many domains, such as forecasting knock-on effects of events in markets, and in particular to forecasting knock-on effects of climate events (e.g., wildfires, droughts, floods, hurricanes, tornadoes, and the like) in commodity markets.

In some embodiments, a fine-tuned GPT may be used to translate climate and market characteristics into GPT-generated, event-specific features which may then be used to inform the prediction of commodity volatility during an estimated time period of significance by an LSTM. Some embodiments of the disclosed hybrid combination of GPT and LSTM may provide significantly more accurate predictions (e.g. a reduction in mean absolute percentage error by up to 200% relative to previous systems, in some cases). Some embodiments represent advances in hybrid GPT-machine learning architectures which may provide insights to inform risk management strategies as well as climate-related investment strategies.

In certain jurisdictions, regulations may require an organization to disclose risks with respect to transitional physical climate risk, as well as comment on how such risks affect the organization's business model and strategy (e.g., the B15 guidelines from Office of the Superintendent of Financial Institutions (OSFI) in Canada). As such, systems and methods described herein may facilitate compliance with regulations of this nature.

In some embodiments, a system which leverages the advanced capabilities of GPTs for qualitative analysis, can transform qualitative insights to a format compatible with LSTM networks, and leverages LSTM networks for quantitative predictions, may be useful in forecasting direct impacts on, for example, commodity prices, but also provide broader market implications. This combined GPT-LSTM approach may provide a robust framework for navigating the increasingly complex dynamics of global markets, and may aid stakeholders in devising effective risk management and investment strategies.

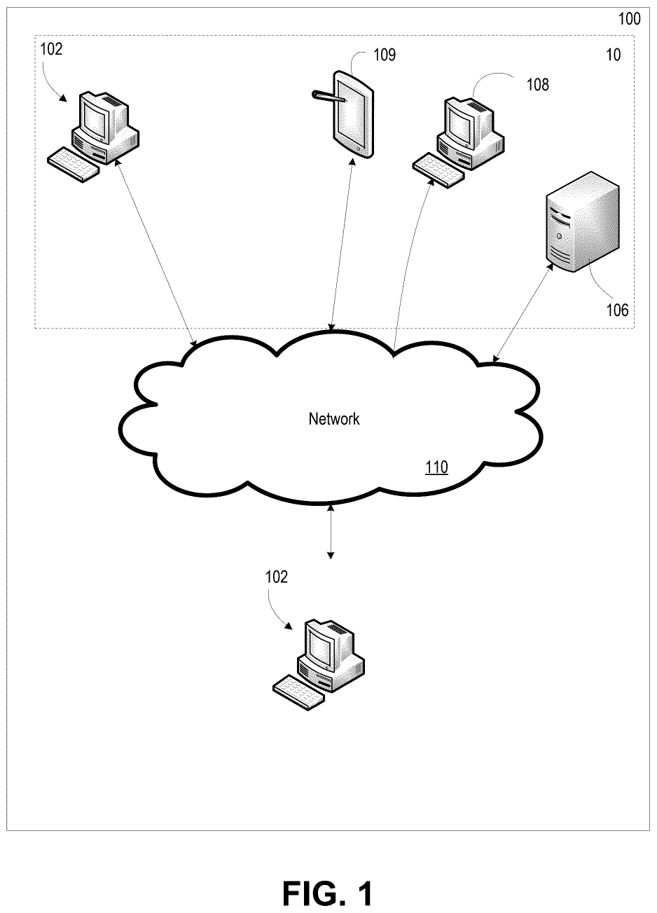

Various embodiments of the present invention may make use of interconnected computer networks and components. FIG. 1 is a block diagram depicting components of an example computing system 100. Components of the computing system are interconnected to define an analysis and prediction generation system. As used herein, the term “analysis and prediction generation system” refers to a combination of hardware devices configured under control of software and interconnections between such devices and software.

As depicted, the operating environment may include a variety of clients incorporating and/or incorporated into a variety of computing devices which may communicate with other computing devices 102 via one or more networks 110. For example, a client 102 may incorporate and/or be incorporated into client application implemented at least in part by one or more computing devices. Example computing devices may include, for example, at least one server 102 with a data storage 118 such as a hard drive, array of hard drives, network-accessible storage, or the like; at least one web server 106, and a plurality of client computing devices 108. Server 102, web server 106, and client computing devices 108 may be in communication by way of a network 110. More or fewer of each device are possible relative to the example configuration depicted in FIG. 1. In some embodiments, one or more computing devices may be logically internal to an organization 10 (depicted in FIG. 1 as devices 102, 109, 108 and 106 being internal to organization 10).

Network 110 may include one or more local-area networks or wide-area networks, such as IPv4, IPv6, X.25, IPX compliant, or similar networks, including one or more wired or wireless access points. The networks may include one or more local-area networks (LANs) or wide-area networks (WANs), such as the internet. In some embodiments, the networks are connected with other communications networks, such as GSM/GPRS/3G/4G/LTE/5G networks.

In some embodiments, the computing system 100 may provide access to one or more software applications. In some embodiments, components of systems such as analysis and prediction generation system 126 may be executed locally within organization 10, without requiring the extensive computing resources of external computing platforms (such as cloud services platforms). In still other embodiments, system 126 may include sending and receiving information, requests and responses to third party services external to the organization 10.

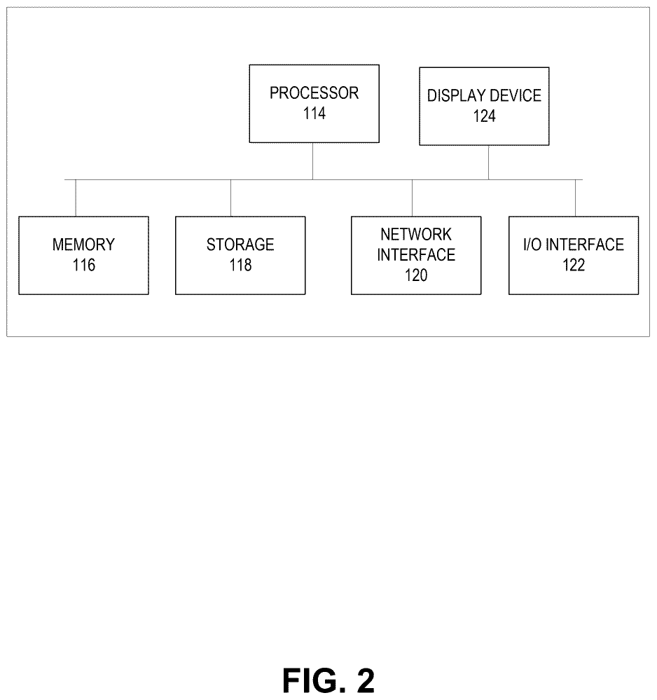

FIG. 2 is a block diagram depicting components of an example computing device, such as a desktop computing device 102, client computing device 108, tablet 109, mobile computing device, and the like. As depicted, an example computing device may include a processor 114, memory 116, persistent storage 118, network interface 120, and input/output interface 122.

Processor 114 may be an Intel or AMD x86 or x64, PowerPC, ARM processor, or the like. Processor 114 may operate under the control of software loaded in memory 116. Network interface 120 connects the computing device to network 110. Network interface 120 may support domain-specific networking protocols for certain peripherals or hardware elements. I/O interface 122 connects the computing device to one or more storage devices and peripherals such as keyboards, mice, pointing devices, USB devices, disc drives, display devices 124, and the like.

In some embodiments, I/O interface 122 may connect various hardware and software devices used in connection with the systems and methods described herein to processor 114 and/or to other computing devices. In some embodiments, I/O interface 122 may be compatible with protocols such as WiFi, Bluetooth, and other communication protocols.

Software may be loaded onto one or more computing devices. Such software may be executed using processor 114.

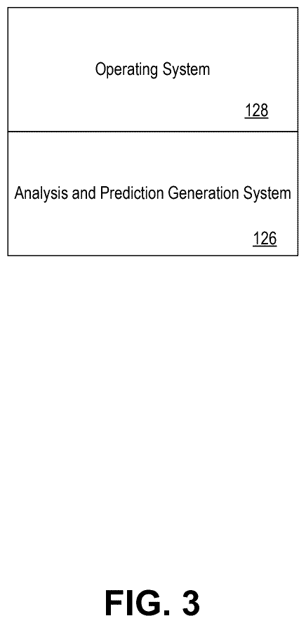

FIG. 3 depicts a simplified arrangement of software at an example computing device. The software may include an operating system 128 and application software, such as analysis and prediction generation system 126. It will be appreciated that in some computing environments, such as distributed computing environments, implementation, and administration of a service such as system 126 may be distributed amongst a plurality of separate computing devices within and/or external to an organization 10, and FIG. 3 is intended to depict a simplified logical separation between an operating system 128 and an application executing on one or more computing devices.

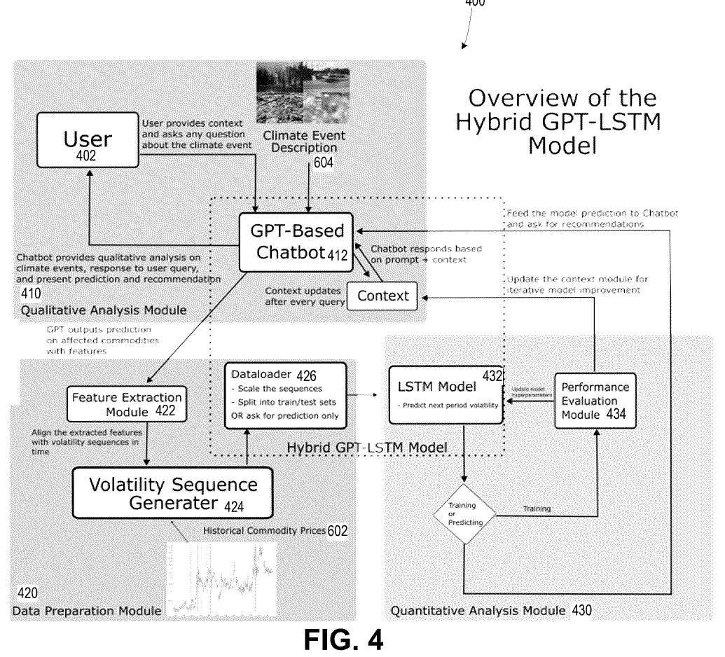

FIG. 4 depicts a logical system architecture diagram for an example analysis and prediction generation system 400, in accordance with some embodiments. Some embodiments of the depicted hybrid GPT-LSTM model may integrate qualitative insights derived from GPT with quantitative forecasting through LSTM networks. As depicted, system 400 may include a qualitative analysis module 410, a data preparation module 420, and a quantitative analysis module 430.

In some embodiments, the qualitative analysis module 410 model operates through a chatbot 412 interface, in which users 402 can input descriptions of climate events, and/or ask questions. The GPT component may then process these descriptions to perform qualitative analysis, and may extract critical information about potential impacts of a climate event on commodity markets. The chatbot 412 may be configured to analyze textual descriptions of climate events to generate insights into potential market impacts, identify affected commodities, and/or extract pertinent features, as explained below. In some embodiments, the extracted features may be subsequently used to transform the qualitative analysis into quantitative features.

In some embodiments, the extracted features may be aligned with historical commodity price data by the feature extraction module 422, which may serve as an input for the quantitative analysis phase. The use of structured prompts with GPT 412 may facilitate outputs from the GPT which follow a predictable format. For example, a pattern may be used in prompts consistently, so that patterns in the output of the GPT can be recognized in in a predictable manner, which may facilitate feature extraction.

In some embodiments, the LSTM networks 432 may be used to predict future market volatility based on the combined dataset of historical price data and extracted features. In so doing, the LSTM 432 may capture temporal dependencies and trends in the data, which may enable more accurate forecasting of the next period's volatility.

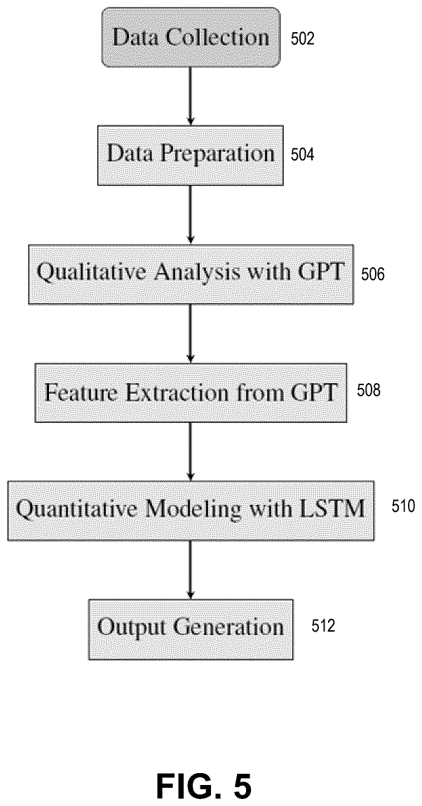

FIG. 5 is a flow chart depicting example operations that system 400 might perform to implement a hybrid GPT-LSTM predictive modeling pipeline. As depicted, system 400 may integrate the qualitative analytical power of GPT with the quantitative forecasting capabilities of LSTM networks. In some embodiments, the approach may be structured in two main phases: qualitative analysis using GPT to extract insights on event impacts, and quantitative modeling with LSTM to forecast future volatility based on the GPT-generated insights.

As depicted, an example predictive modeling pipeline process might begin with data collection 502. Data collection may include, for example, gathering historical financial data including commodity prices, locations, sectors, types of climate events, and the like, which may be used to infer relationships between different commodities, locations, sectors, and types of events. In some embodiments, historical commodity price data 602 may be collected using scripts designed to interact with the API for a commodity. An example API which may be suitable is the Commoditic API. In some embodiments, commodity price data can be requested over specified time intervals to ensure comprehensive coverage.

In some embodiments, collected data may include historical pricing data for commodities across up 5 primary sectors (e.g., energy, livestock, agricultural, industrial, and metals). For example, in some embodiments, the energy sector may include one or more of brent, coal, crude oil, ethanol, gasoline, heating oil, methanol, naphtha, natural gas, propane, TTF gas, UK gas, Urals oil, and uranium. In some embodiments, the livestock sector may include one or more of beef, eggs CH, eggs US, feeder cattle, lean hogs, live cattle, poultry, and salmon. In some embodiments, the agricultural sector may include one or more of butter, canola, cheese, cocoa, coffee, corn, cotton, lumber, milk, oat, orange juice, palm oil, potatoes, rapeseed, rice, rubber, soybeans, sugar, sunflower oil, tea, wheat, and wool. In some embodiments, the industrial sector may include one or more of aluminum, bitumen, cobalt, di-ammonium, gallium, germanium, indium, iron ore, kraft pulp, lead, magnesium, manganese, molybdenum, neodymium, nickel, palladium, polyethylene, polypropylene, polyvinyl, rhodium, soda ash, tellurium, tin, urea, urea ammonium, and zinc. In some embodiments, the metals sector may include one or more of copper, gold, HRC steel, iron ore, lithium, platinum, silver, steel, and titanium.

In some embodiments, the price volatility for various commodities may be calculated based on historical data using:

$${Volatility}_{t} = \sqrt{\frac{1}{N} {\sum }_{i = 1}^{N} {( log ( \frac{{P}_{t}}{{P}_{t - 1}} ) - μ )}^{2}}$$

where Pₜ represents the price at time t, and μ is the mean of log returns calculated over a historical window.

In some embodiments, data relating to climate events 604 may be acquired from reputable news agencies and government websites (e.g., the National Integrated Drought Information System (NIDIS) can be used to acquire drought information). In some embodiments, climate events may be characterized by its description and the exact timestamp of occurrence to increase the probability of accurately gauging the event's impact on commodity markets.

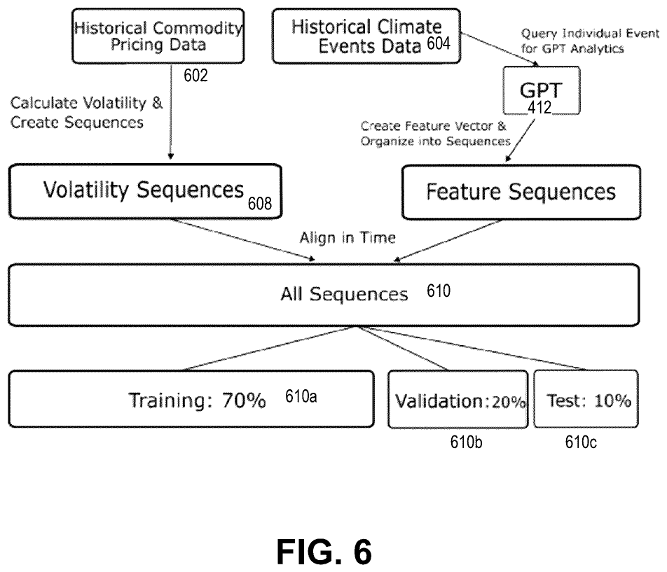

At block 504, system 400 begins a data preparation phase to ensure that the collected data is in the proper condition for formatting. Data preparation 504 may include, for example, one or more of data cleaning, normalization, and transformation so as to prime the data for both qualitative and quantitative assessments. FIG. 6 depicts an example data preparation process, in accordance with some embodiments.

In some embodiments, the intensity/severity of climate events may be quantified. In some embodiments, the following formula may be used to quantity severity of climate events:

$${intensity}_{i , t}^{k} = \{ \begin{matrix}1 , & if \text{?} \\ 2 , & otherwise\end{matrix}$$

$$\text{?} \text{indicates text missing or illegible when filed}$$

where k=1, 2, 3 is the type of disaster, i represents the country, and the event occurs at time t in months. The intensity value may be 1 when the sum of the number of fatalities and 30% of the number of affected people is greater than the threshold ā, and otherwise 0. Events having a value of 1 are classified as moderate or severe disasters. In some embodiments, ā may have a value of 0.0001 (meaning 0.01% of the population) for moderate climate events. In some embodiments, ā may have a value of 0.01 for severe climate events.

At block 506, a qualitative analysis is performed using a GPT (such as, for example, OpenAI's GPT-3.5). The GPT's capabilities for processing natural language can be leveraged to interpret and quantify the effects of climate events on commodity prices, which may otherwise represent a significant challenge using only numerical data. In some embodiments, a GPT-3.5 based chatbot 412 may be accessed via an API provided by OpenAI.

In some embodiments, chatbot 412 may be configured to receive a detailed description of a climate event as an input. In some embodiments, the chatbot 412 may be presented with one or more prompts configured to return specific formats of data. An example prompt might be “what is the scaled relationship between commodities?” or “what is the relationship between sector x and sector y”. In some embodiments, the prompts may be structured to obtain responses which are conducive to being transformed to numerical values. The GPT-based chatbot 412 may be further configured to respond to inquiries from users 402 about a specific event. In some embodiments, the chatbot 412 may be configure to generate detailed reports on one or more climate events. In some embodiments, such reports may specify one or more of immediate and subsequent impacts on commodity pricing trends, the sequence of impacted commodities, the magnitude of price change, and the timeframe for these trends.

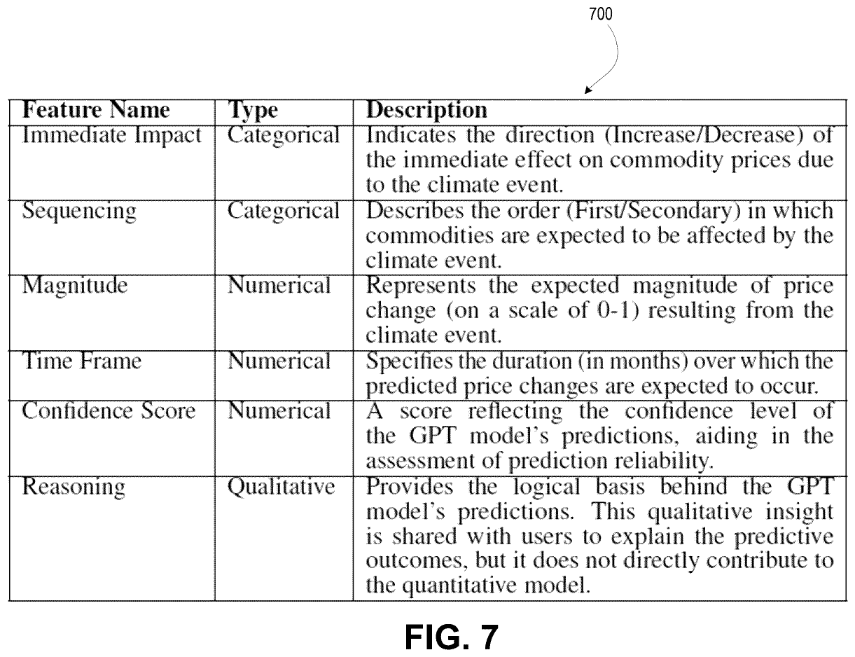

Some embodiments may include a reciprocating interaction with the GPT model. For example, queries may be structured to include event descriptions (e.g. Python functions structured queries), and prompts may be tailored to solicit analyses in a predefined format from the GPT model. This approach may allow for critical features to be distilled from the chatbot 412's responses, which may facilitate the transformation of qualitative insights by the chatbot 412 into quantifiable data. FIG. 7 depicts a list of example features 700 which may be integrated into a quantitative model to refine volatility forecasts. As depicted, example features may include, but are not limited to, immediate impact, sequencing, magnitude, time frame, confidence score, and reasoning.

As explained in FIG. 7, the immediate impact feature may indicate the direction (e.g., price increase or price decrease) of the immediate effect on commodity prices due to a climate event. The sequencing feature may describe the order (e.g. first or secondary) in which commodities are expected to be affected by a climate event. The magnitude feature may represent the expecting magnitude of price change (e.g., on a scale of 0 to 1) resulting from the climate event. The time frame feature may specify the duration (e.g., in months) over which the predicted price changes are expected to occur. The confidence score feature may reflect the confidence level of the GPT model's predictions, which may be useful in a subsequent assessment of prediction reliability. The reasoning feature is a qualitative feature which may provide user 402 with an explanation or logical basis for the GPT model's predictions. In some embodiments, the reasoning feature might not contribute to the quantitative model's predictions, but may provide an informative experience to user 402, which may provide some trust or credibility to the model's results.

An example prediction for lean hog pricing after the 2023 US Midwest drought might appear as follows:
“Commodity: Lean Hogs
Immediate Impact: Increase,
Sequencing: Tertiary
Magnitude: 0.3,
Time frame: 5 months
Reasoning: The increase in corn and soybean prices will elevate the costs of feedstock for pork production. This impact will follow the rise in corn and soybean prices, affecting pork prices after a certain lag as producers adjust to higher input costs.”

As will be appreciated from the above-noted example, the ‘reasoning’ section may provide an explanation of the cause-and-effect dynamics influencing commodity prices, thereby offering users a narrative that contextualizes the forecasts, rather than numbers or quantities without context or explanation.

Returning to FIG. 6, which depicts an example data preparation process for training a hybrid GPT-LSTM model, and as explained above, the price volatility for various commodities may be determined based on the historical price data 602 that has been collected. In some embodiments, the monthly volatility of a commodity represents the standard deviation of the monthly returns of the asset over a specified time period. The volatility may measure the amount of variation or dispersion from the average return, indicating the level of risk associated with the asset's price changes over that period. As will be appreciated, the volatility calculation process is of fundamental importance in transforming raw historical price data into a volatility metrics, which may then serve as a quantitative indicator of price movement over time. In some embodiments, the initial step may include calculating monthly returns. In some embodiments, using log returns as model inputs may provide a more stable and continuous measure of returns, which may be advantageous in modeling the nuances of noisy price movements over time. Log returns may be computed by taking the logarithm of the ratio of prices in consecutive time periods:

$$Returns = log ( \frac{{Price}_{t}}{{Price}_{t - 1}} )$$

where Priceₜ denotes the price of a commodity at time t, and Priceₜ₋₁ denotes the price of the commodity at that time a month prior.

Following the determination of monthly returns, the standard deviation of these monthly returns may be used to derive monthly volatility, which provides an indication of the fluctuations in returns over time. In some embodiments, the monthly volatility may include all available historical data up to the current month for each calculation. For example, using an expanded window for the standard deviation calculation may allow for the inclusion of all historical data up to the current time period, thereby capturing the aggregate effect of price fluctuations on volatility, according to the formula:

$$Monthly Volatility = \sqrt{\frac{\sum {( Monthly Returns - Mean Monthly Returns )}^{2}}{n - 1}}$$

where n represents the total number of monthly returns used in the calculation, and Mean Monthly Returns is the average of Monthly Returns over the time period considered. It will be appreciated that more data will become available with each subsequent time period of data observed (e.g., if price data begins is available for June 2018 and onward, then volatility data for August 2018 would include data for June and July, whereas the volatility dataset for March 2024 would include data for all monthly returns between June 2018 and February 2024).

In some embodiments, once the volatility data has been calculated, the volatility data may be normalized. In some embodiments, normalizing may include re-scaling the volatility data from a scale of 0 to 1.

In some embodiments, extracted qualitative features 700 may be translated into a structured form. For example, feature engineering may transform features 700 into a numerical format which can be interpreted by the LSTM. In some embodiments, an example feature engineering process may include encoding categorical features (e.g., immediate impact direction and sequence) into binary or ordinal formats. In some embodiments, the magnitude and/or time frame features may be converted from textual to numerical representations. For example, a GPT-predicted timeframe text string of “3 months” could be converted by feature engineering to a numerical value of “3”, and saved as an element of an extracted GPT feature array or feature vector 606.

In some embodiments, volatility sequence generator 424 may be configured to generate sequences in which each sequence of features is aligned with sequences of commodity price volatility based on timestamp alignment. For example, for a given commodity, historical volatility data may be segmented into volatility sequences 608. In some embodiments, each segment may have a specified temporal length. In some embodiments, a temporal length of 6 months may be used for sequences. In some embodiments, a temporal length of 6 months has been found to yield accurate predictions for monthly volatility.

In some embodiments, each sequence may be associated with a feature vector from the GPT-generated dataset if the ending date of the sequence matches one of the feature timestamps. In some embodiments, if no corresponding feature vector exists with an ending date that matches a feature timestamp, then a default zero vector may be used. In some embodiments, assigning vectors in this manner may help to ensure that every input sequence provided to the LSTM model is accompanied by a feature set, whether from GPT-generated predictions, or from a neutral placeholder.

In some embodiments, sequences and corresponding feature vectors may then be structured into arrays 610 which may be suitable for model training. In some embodiments, the arrays may be subdivided into training 610a, validation 610b and testing 610c sets for training LSTM model 432 via data loader 426.

In some embodiments, system 400 uses a layered LSTM network configured to handle sequential data and recognize patterns over time. In some embodiments, the architecture of LSTM model 432 includes a first pathway comprising multiple LSTM layers for processing historical volatility sequences, a second parallel pathway comprising dense layers for processing integrated GPT-generated features, and a concatenation layer for merging these pathways. As described herein, a dense layer refers to a fully connected layer in which each input node is connected to each output node. Dense layers may be useful for combining features across inputs, and/or to reduce dimensionality before making predictions.

In some embodiments, training and validation data may be used to establish a baseline LSTM model which is configured to process historical commodity volatility data. The baseline LSTM model may then be enhanced with additional GPT-extracted features from climate events. In some embodiments, LSTM layers may be constructed and integrated using, for example, the TensorFlow and Keras open-source libraries which are publicly available.

In some embodiments, a baseline LSTM architecture may include an input layer, one or more LSTM layers, and an output layer. In some embodiments, the input layer may be configured to accept sequences of historical volatility, with each sequence representing a fixed window (or sequence length) of past volatility values (e.g. a 6 month window). This sequence length may be determined based on, for example, preliminary analyses to capture relevant temporal patterns in the sequence data. For example, for a commodity, a sequence length of 6 may be used (which corresponds to historical volatility data from the past 5 months to generate predictions for the next month (i.e. the 6^{th} month)).

In some embodiments, one or more LSTM layers follow the input layer of the baseline LSTM model. In some embodiments, a first LSTM layer may be configured to return sequences to allow for further temporal processing at subsequent layers. In some embodiments, subsequent LSTM layers after the first LSTM layer may be configured to return a final output. In some embodiments, returning a final output may facilitate condensing learned temporal features into a representation which is more suitable for predictions.

In some embodiments, the baseline LSTM model includes an output layer which is configured based on the prediction horizon (e.g., dependent on whether forecasting immediate volatility in the next time period, or extending to multiple future time periods). The baseline output layer may be a dense layer with a single neuron, which is configured to predict the volatility of the next (i.e. subsequent) period. In some embodiments, the final layer may forecast immediate future volatility based on historical data patterns.

In some embodiments, the baseline LSTM model may be trained using a mean squared error (MSE) loss function. In some embodiments, the loss function may be optimized through Adam optimization. Adam optimization may be particularly effective in handling non-linear and temporal dependencies expected to be present in datasets such as volatility data.

In some embodiments, LSTM model 432 includes an enhanced LSTM model architecture which builds upon the baseline LSTM model by incorporating additional feature sets generated from the GPT-based qualitative analysis of climate events. In some embodiments, the incorporation of feature sets from qualitative analysis may augment the LSTM model 432's predictive capabilities by including indications of how forthcoming climate events may influence volatility of one or more commodities.

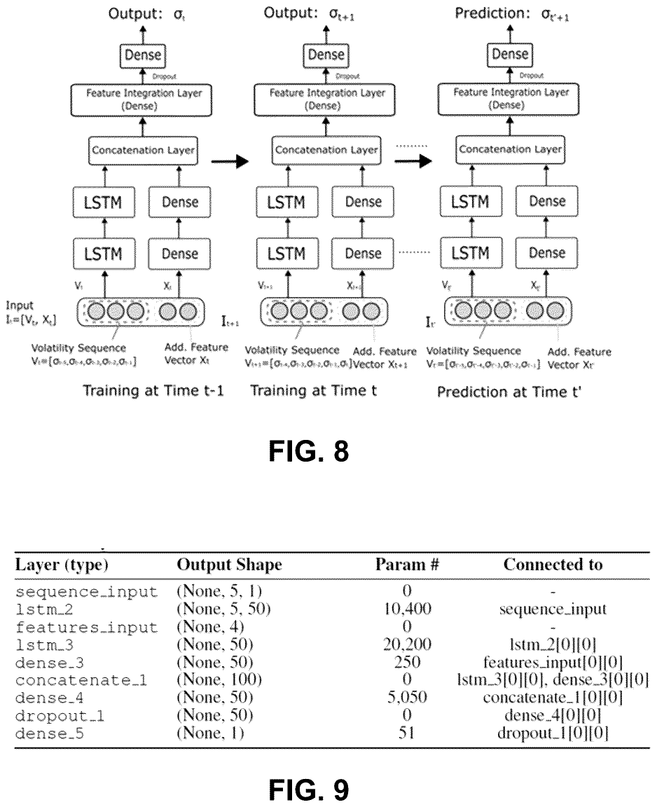

FIG. 8 depicts an example enhanced LSTM architecture 800, in accordance with some embodiments. FIG. 9 depicts a table outlining the various layers depicted in enhanced LSTM architecture 800. As depicted in FIG. 8, in addition to the above-noted LSTM layers processing historical volatility sequences, the enhanced LSTM architecture 800 may include a feature integration layer, a concatenation layer, and an extended output layer.

In some embodiments, the feature integration layer is a pathway parallel to the layers processing historical volatility sequences, in which the parallel pathway includes dense layers which process the GPT-generated feature vectors. Since feature vectors encode qualitative insights into numerical formats, the feature vectors may allow the enhanced LSTM to capture the immediate impact, sequencing, magnitude, and/or timeframe of climate events on one or more commodities.

In some embodiments, the LSTM pathway and the feature integration layer (i.e. the parallel pathway having dense layers for processing GPT-generated features) may converge at a concatenation layer. In some embodiments, the concatenation layer may merge the temporal features learned from historical volatility data with the insights provided by the GPT-generated features, which may create a unified feature set for making future predictions.

In some embodiments, the enhanced LSTM architecture 800 may further include an extended output layer. In some embodiments, the extended output layer may include a plurality of neurons (in contrast with a single neuron in the output layer of a baseline LSTM model), each predicting volatility for subsequent periods within the forecast horizon. Thus, the extended output layer may be configurable to generate multi-period forecasts, which may offer a forward-looking view of volatility in the wake of anticipated climate events, beyond the immediate future.

In some embodiments, the enhanced LSTM model may undergo training with a dataset which is enriched by the GPT-generated features, and may leverage the same MSE loss function and Adam optimizer used by the baseline LSTM. In some embodiments, the training process may ensure that the LSTM model learns to integrate both historical volatility patterns and anticipate impacts of future climate events, which may serve to deliver more accurate and actionable forecasts.

In some embodiments, the baseline and enhanced LSTM models may undergo training and validation processes. As depicted in FIG. 6, sequences 610 may be subdivided into training set 610a, validation set 610b, and test sets 610c to test the accuracy of predictions. In some embodiments, the temporal order of sequences may be maintained (e.g., training data 610a is temporally earlier than validation set 610b, and so on) in order to avoid creating a look-ahead bias.

In some embodiments, a training process includes fitting the LSTM model to the data using an MSE loss function. Some embodiments may further include the use of an Adam optimizer. The training and validation process may be performed using open-source libraries, such as the Keras and TensorFlow libraries. For example, the Keras and TensorFlow APIs may be accessible by system 400, which allows for the configuration of training parameters and the execution of the training process. In some embodiments, the models' performances may be evaluated based on one or more of MSE, Mean Absolute Error (MAE), as well as additional relevant metrics with a view to the enhanced model's ability to leverage GPT-generated features to improve forecasting accuracy.

In some embodiments, output from the LSTM model 432 may be provided to performance evaluation module 434 for validation. In some embodiments, the LSTM model 432's predictive performance may be based on the Root Mean Squared Error (RMSE) metric, which measures the differences between values predicted by model 432 and the values actually observed. RMSE may be a particularly useful metric in quantifying the magnitude of error in the prediction produced by model 432, which may allow for the accuracy of model 432 to be assessed. In some embodiments, one or more other metrics (e.g., MSE, MAE, Mean Absolute Percentage Error (MAPE)), or combinations thereof, may be used to provide a more comprehensive assessment of the accuracy of model 432.

In some embodiments, after the model has been trained and validated, an in-depth, granular analysis of the model's performance may be performed using the predictions produced by model 432 for the test dataset 610c. In some embodiments, the evaluation may include a meticulous comparison of predicted and actual observed volatilities. Any significant variances may be highlighted for further examination and modification of the LSTM model 432.

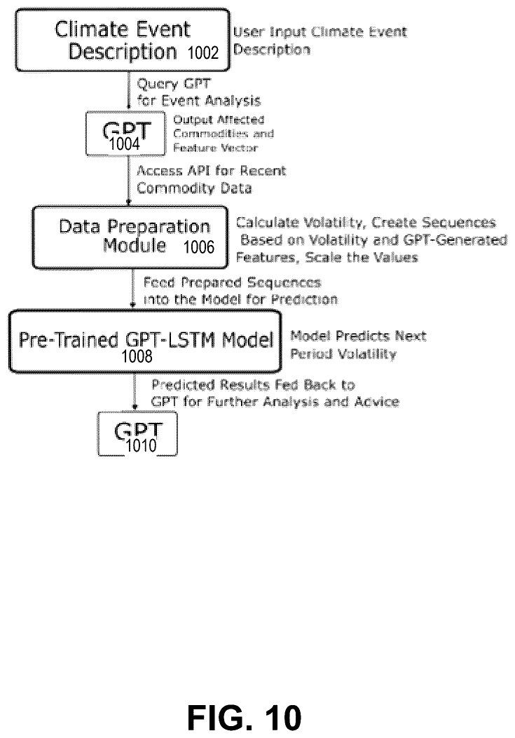

At block 512, after training is complete, enhanced LSTM model 432 may be used to make predictions. Forecasted volatility values may be produced, which offer tangible predictions that may be used to inform any number of decision-making processes relevant to commodity markets and resource allocation more generally. FIG. 10 depicts an example workflow diagram for generating predictions using system 400.

At block 1002, a user may input a detailed description of a climate event into system 400. At block 1004, the GPT chatbot, which has been trained to analyze descriptions of climate events, may process the description to determine affected commodities and generate a corresponding feature vector for each commodity. In some embodiments, the feature vector may include the expected immediate impact, sequencing, magnitude, and the estimated time frame of the climate event's effect on each commodity (as shown, for example, in FIG. 7).

At block 1006, data preparation module 420 may access the most current commodity data (e.g. via Commoditic API), and calculate the current volatility. In some embodiments, data preparation module 420 may then combine the volatility data with the GPT-generated feature vector to create a sequenced dataset. In some embodiments, the sequenced dataset may be scaled and/or normalized to comply with the parameters which were used to train the LSTM model.

At block 1008, the sequenced data may then be provided to the pre-trained GPT-LSTM model, which may be configured to forecast future volatility for one or more commodities based on historical data augmented with the GPT-extracted event impacts. In some embodiments, the model may predict the volatility for the next time period (e.g. 1 month), and may provide a numerical estimate of the expected market volatility.

At block 1010, and as depicted in FIG. 4, the predicted results may be fed back to GPT 412. In some embodiments, GPT 412 may generate advice or insights based on the combined quantitative predictions and/or qualitative event descriptions. In some embodiments, this iterative feedback mechanism may also allow for continuous refinement of predictions and/or the incorporation of the most current market data and/or climate event information.

Experimental validation results using systems in accordance with some embodiments described herein have resulted in improved accuracy in predictions relative to previous systems. Moreover, some experimental results were collected using a LSTM network reliant solely on historical price data, and compared with results generated by the enhanced LSTM model's predictions with the benefit of GPT-generated feature extraction and insights. In this example, models were applied to a historical scenario of the June 2023 US Midwest Drought, which has known results to which generated predictions can be compared.

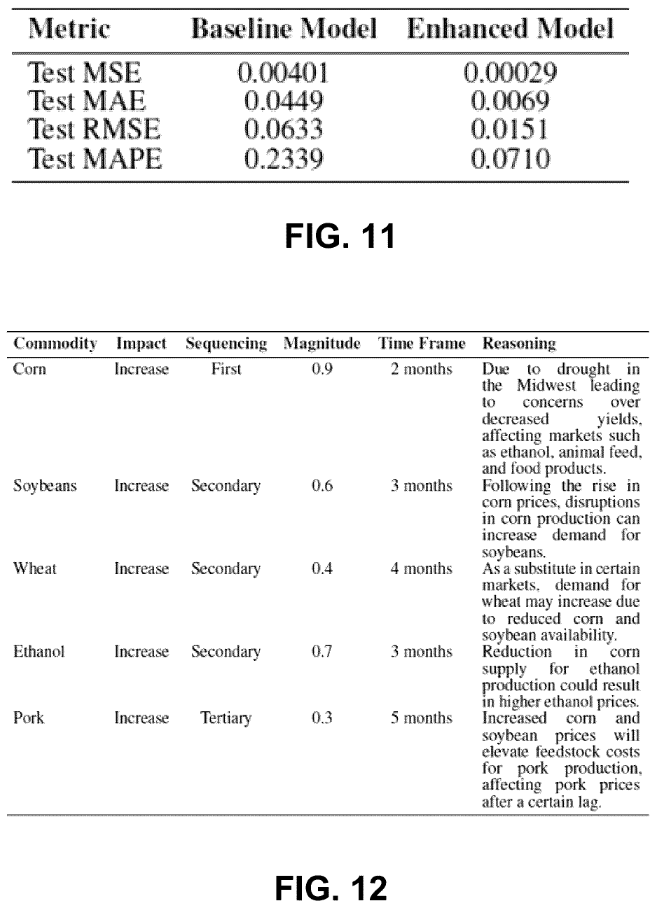

FIG. 11 is a table depicting a comparison of the results of the baseline LSTM model with the enhanced GPT-LSTM model. As will be appreciated, the various error metrics are substantially lower relative to all of the error metrics (MSE, MAE, RMSE, MAPE). As such, this comparative analysis demonstrates the significant improvement in predictive accuracy which some embodiments described herein may provide relative to previous forecasting systems. Moreover, the feedback nature of system 400 provides that with each iteration, the hybrid GPT-LSTM model may become increasingly accurate.

Moreover, experimental results demonstrate the significant insights into immediate and subsequent impacts on commodity pricing which can be discovered using some embodiments of system 400. A summary of predicted effects is provided in a table in FIG. 12. For example, the GPT-generated analysis revealed that the drought had a direct and potent impact on commodities such as corn (with an increase in prices by 90% over the subsequent 2 months), primarily due to the anticipated decrease in yields, which would affect markets reliant on corn. An example knock-on effect was seen in the price of soybeans, which saw an increase in demand and subsequent price escalation of 60% over the following 3 months, due to being a rotational crop with corn. In some embodiments, generated projections may highlight the complex interdependencies within commodity markets and extended effects which may manifest over time from a climate event. For example, ethanol prices were also predicted to rise by 70% in the subsequent 3 months as a secondary effect of the rise in corn price. Moreover, as a tertiary effect, pork prices were projected to increase by 30% after 5 months, due to the increased costs of feedstock resulting from higher corn and soybean prices. The predicted lag in the impact on pork prices may reflect the time required for producers to adjust to new cost realities associated with feedstock.

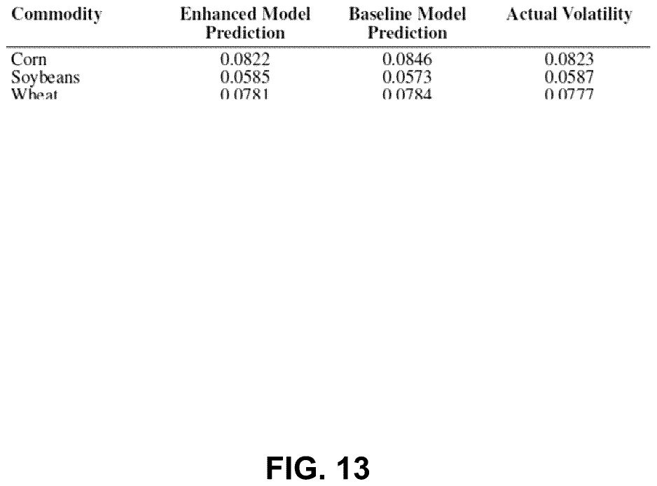

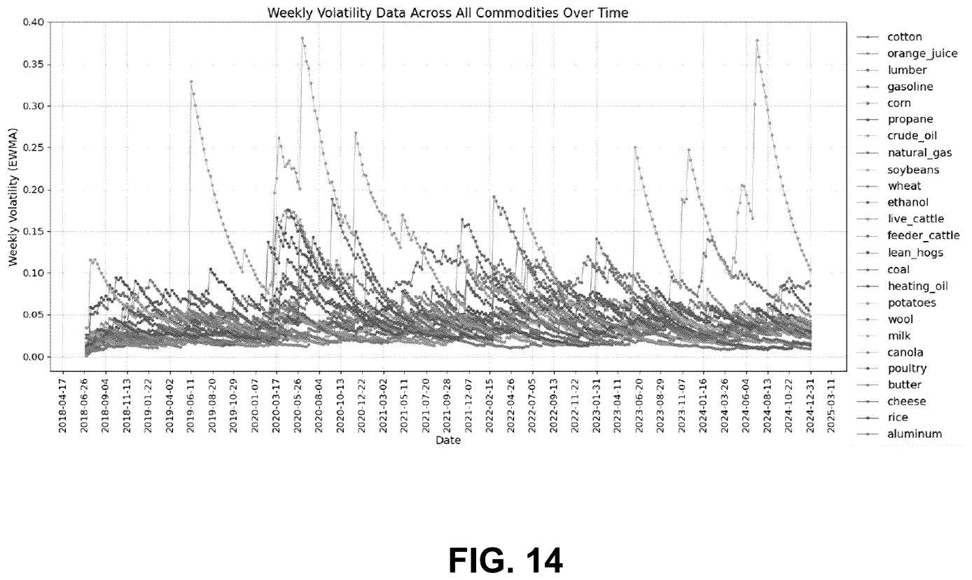

FIG. 13 provides a comparison of predicted versus actual volatility data for the July 2023 time period. As can be seen, the enhanced GPT-LSTM hybrid model incorporating GPT-generated features showed a marked improvement in alignment with actual observed market volatility. Moreover, the predictions by the enhanced model were consistently closer to actual observed volatility for all commodities.

In some embodiments, using GPT-generated insights may bolster the LSTM model's forecasting accuracy for commodity volatility during climate events. More broadly, it can be observed that the use of a GPT to generate insights based on textual data which is then transformed to quantitative data for use in an enhanced LSTM model may provide significant advancements in the resulting accuracy of generated predictions. Although the examples described herein relate primarily to predicting commodity price volatility as a consequence of climate events, it will be appreciated that principles described herein may be similarly applied for generating predictions in any situation in which historical data is available and able to be temporally aligned with features extracted from textual inputs. For example, models might be able to better predict the effects of geopolitical events, economic indicators, and/or technological advancements, which may also affect commodity prices.

In some embodiments, the quality and detail of the textual information (e.g. climate event descriptions) used as an input for the GPT model may have a substantial impact on the accuracy of subsequent predictions. In some embodiments, the GPT's ability to generate nuanced and contextually relevant features tends to depend on the specificity and comprehensiveness of the descriptions provided (e.g., the explicit mention of a geographic location of a climate event may have a significant improvement on the accuracy of predictions). As such, detailed and precise prompts provided to the GPT may be important for eliciting meaningful qualitative insights that can be transformed into accurate quantitative features for the LSTM model.

The development and implementation of a hybrid GPT-LSTM predictive model for predicting volatility of commodities may serve as a powerful tool for numerous sectors. For example, policy makers may utilize forecasts to better understand economic impacts of climate change, facilitating more informed decision-making regarding agricultural subsidies, import-expert policies, and/or emergency funding allocations. For example, accurate predictions may help in formulating policies which stabilize food prices during times of high volatility. Moreover, agricultural companies may be able to leverage predictions to optimize production planning, supply chain logistics, and pricing strategies following a climate event. For example, crops expected to be less vulnerable to forecasted climate conditions may be selected for planting. Moreover, insurance firms operating in the agricultural sector may be able to better understand the likely impact of climate events, which can result in adjusting premiums to better reflect the risk of crop failures, for example.

In some embodiments, data collection 502 may include commodity price data pre-processing. Commodity price data may be collected, for example, using automated scripts configured to interact with a database such as the Commoditic API. For example, scripts may periodically obtain price data for a set of commodities, including one or more of energy, livestock, agricultural, industrial, and metal commodities. Examples of energy commodities may include propane, natural gas, ethanol, heating oil, crude oil, and/or gasoline. Examples of livestock may include live cattle, feeder cattle, lean hogs, and/or poultry. Examples of agricultural commodities may include cotton, orange juice, lumber, corn, soybeans, wheat, potatoes, wool, milk, canola, butter, cheese, and/or rice. An example industrial commodity may be aluminum.

In some embodiments, separate API calls may be used for each selected commodity. In some embodiments, an API call may include a plurality of commodities. In some embodiments, the results from API calls may be stored as JSON files. In some embodiments, an individual JSON file may be stored for each respective commodity. An example text block from a JSON file may be: [{“price”: “2047.5”, “date”: “2018-07-25” }, {“price”: “2072”, “date”: “2018-07-24” }, {“price”: “2057.75”, “date”: “2018-07-23” }, {“price”: “2024”, “date”: “2018-07-20” }, {“price”: “1986.75”, “date”: “2018-07-19” }, . . . ].

In some embodiments, the obtained commodity price data may be converted to weekly volatility data. For example, daily commodity price data may be converted to weekly volatility data using an Exponentially Weighted Moving Average (EWMA) or any other suitable approach for assessing deviations. Volatility represents the degree of variation in in values (e.g., in commodity prices) over time and is commonly used in financial analysis to quantify the uncertainty or degree of variation in future price movements.

FIG. 14 depicts example weekly volatility data for various commodities between Jun. 25, 2018 to Dec. 20, 2024. As depicted, weekly logarithmic volatility varies from 0.01 to 0.4. In order to avoid the resulting model from being biased towards commodities with larger absolute amplitudes, the volatility data may be normalized to re-scale and stretch data to a range from 0 to 1. In some embodiments, the MinMaxScaler from the ScikitLearn library may be used to normalize the data. In some embodiments, missing values in the volatility data set may be filled using the nearest value for the volatility data.

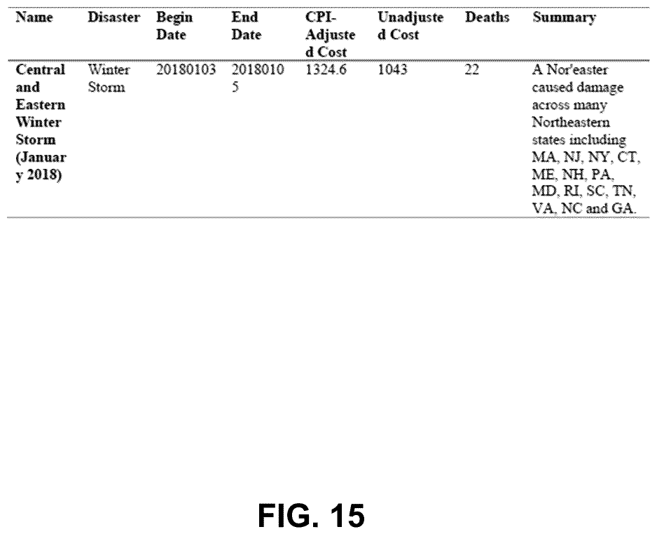

In some embodiments, weather event data may be obtained from the U.S. Billion-Dollar Weather and Climate Disasters data set. This dataset contains the name and type of disaster, the beginning date and end date, unadjusted costs and Consumer Price Index (CPI) adjusted costs, deaths, and a summary of the extreme weather event. For example, between Jun. 25, 2018 and Dec. 30, 2024, the weather event dataset includes 144 climate events. FIG. 15 depicts an example record from the US Billion-Dollar Weather and Climate Disasters dataset, and documents a severe winter storm in January 2018 that affected multiple states in the northeastern and southeastern regions of the United States. As depicted in FIG. 15, the record includes attributes including the event name, disaster type, state and end dates, CPI-adjusted and unadjusted economic costs, the number of fatalities, and a summary of the event's impact. In some embodiments, these descriptions may be useful for a GPT to analyze and model the broader consequences of extreme climate events on commodity price changes.

In some embodiments, a GPT such as OpenAI's GPT-4 may be accessed via the OpenAI API to analyze and interpret event scenarios (such as climate event scenarios). In some embodiments, the text descriptions of climate events may be used to prompt a model to generate structured responses outlining a weather event's anticipated impact on commodity markets. In some embodiments, the model's capabilities may be tailored through prompt engineering techniques.

In some embodiments, the quality and detail of weather event descriptions used as input to the GPT model may have a significant impact on the resulting predictive performance. The GPT's ability to produce nuanced and contextually relevant features may depend materially on how specific and comprehensive the input descriptions of weather events are. For example, including the geographic location of the weather event in the prompt may yield significant improvements in the model's accuracy.

It should be appreciated that although particular embodiments are described in details, these embodiments are meant to be merely examples, and that many variations are contemplated. For example, some embodiments may use LSTM and GPT-generated features which are generated monthly and trained weekly by LSTM models. Some embodiments may use other types of models and GPT-generated features which are generated weekly which are directly trained by the model. Still other embodiments may incorporate feature engineering techniques to refine the GPT output before integration into a model.

Incorporating GPT hybrid climate/weather event features into a volatility forecasting system may improve predictive performance for a wide range of commodities. Across both validation and test datasets, a GPT-hybrid model may consistently outperform a baseline model which does not incorporate GPT-engineered climate/weather features, in terms of standard error metrics (e.g., MSE, MAE, RMSE).

Of course, the above-described embodiments are intended to be illustrative only and in no way limiting. The described embodiments are susceptible to many modifications of form, arrangement of parts, details, and order of operation. The invention is intended to encompass all such modifications within its scope, as defined by the claims.

What is claimed is:

1. A method of analyzing data and generating predictive forecasts, the method comprising:
receiving, at a qualitative analysis module, historical event data comprising text data describing a plurality of events over a first time period;
extracting, from said historical event data, a plurality of features using a generative pre-trained transformer (GPT);
transforming said extracted features to a numerical value;
receiving, at a data preparation module, historical financial data for one or more assets over a second time period;
determining one or more metrics based on said historical financial data;
generating at least one training sequence including said transformed numerical values of said extracted features and said one or more metrics;
training, at a quantitative analysis module, a predictive model using said at least one training sequence;
receiving text data relating to a current event outside of said first time period;
extracting, from said text data relating to said current event, a plurality of current features using said GPT;
generating, by said predictive model, a prediction relating to one or more of said metrics for one or more of said assets for a future time period.

2. The method of claim 1, wherein said extracted features include at least one of a direct impact, a cascading impact, a sequence of effects, a magnitude, a time frame, and a confidence score.

3. The method of claim 1, wherein generating said plurality of sequences comprises aligning time periods for said transformed numerical values and said one or more metrics.

4. The method of claim 1, wherein said one or more metrics includes price volatility of said assets.

5. The method of claim 1, wherein said predictive model is an LSTM model, and wherein said method further comprises normalizing and/or scaling values in said plurality of sequences prior to said training said LSTM model.

6. The method of claim 1, wherein said generated prediction relates to at least two future time periods.

7. The method of claim 1, further comprising subdividing said at least one training sequence into one or more training sequences, validation sequences, and test sequences.

8. The method of claim 7, wherein said training sequences are based on a time period earlier in time than said validation sequences.

9. The method of claim 7, further comprising:
comparing, by a performance evaluation module, said generated prediction based on said training sequence to said validation sequences; and
at least one of adjusting hyperparameters of said predictive model and/or re-training said predictive model based on said comparing.

10. The method of claim 1, wherein said assets are commodities.

11. The method of claim 1, wherein said predictive model is an LSTM model comprising a plurality of LSTM layers, a feature integration layer for processing feature vectors, and a concatenation layer for merging the LSTM layers and the feature integration layer.

12. The method of claim 1, wherein said events are climate and/or weather events. Boost model.

13. A system comprising:
one or more processors;
a non-transitory computer-readable storage medium having stored thereon processor-executable instructions that, when executed by said one or more processors, cause said one or more processors to perform a method of analyzing data and generating predictive forecasts, the method comprising:
receiving, at a qualitative analysis module, historical event data comprising text data describing a plurality of events over a first time period;
extracting, from said historical event data, a plurality of features using a generative pre-trained transformer (GPT);
transforming said extracted features to a numerical value;
receiving, at a data preparation module, historical financial data for one or more assets over a second time period;
determining one or more metrics based on said historical financial data;
generating at least one training sequence including said transformed numerical values of said extracted features and said one or more metrics;
training, at a quantitative analysis module, a predictive model using said at least one training sequence;
receiving text data relating to a current event outside of said first time period;
extracting, from said text data relating to said current event, a plurality of current features using said GPT; and
generating, by said predictive model, a prediction relating to one or more of said metrics for one or more of said assets for a future time period.

14. A computer-readable storage medium having stored thereon computer-executable instructions that, when executed by one or more processors, cause the one or more processors to perform a method of analyzing data and generating predictive forecasts, the method comprising:
receiving, at a qualitative analysis module, historical event data comprising text data describing a plurality of events over a first time period;
extracting, from said historical event data, a plurality of features using a generative pre-trained transformer (GPT);
transforming said extracted features to a numerical value;
receiving, at a data preparation module, historical financial data for one or more assets over a second time period;
determining one or more metrics based on said historical financial data;
generating at least one training sequence including said transformed numerical values of said extracted features and said one or more metrics;
training, at a quantitative analysis module, a predictive model using said plurality of training sequences;
receiving text data relating to a current event outside of said first time period;
extracting, from said text data relating to said current event, a plurality of current features using said GPT; and
generating, by said predictive model, a prediction relating to one or more of said metrics for one or more of said assets for a future time period.
